(19) United States
(12) Patent Application Publication
(10) Pub. No.: US 2009/0128515 A1
(43) Pub. Date: May 21, 2009

(54) PROXIMITY SENSING BY INCREASING GAIN IN TOUCHPAD CIRCUITRY AND INCREASING DISTANCE BETWEEN SENSOR ELECTRODES AND A SENSE ELECTRODE

(76) Inventor: Jared G. Bytheway, Sandy, UT (US)

Correspondence Address: MORRISS OBRYANT COMPAGNI, P.C., 734 EAST 200 SOUTH, SALT LAKE CITY, UT, 84102, US

(21) Appl. No.: 12/264,202

(22) Filed: Nov. 3, 2008

Related U.S. Application Data
(60) Provisional application No. 60/985,133, filed on Nov. 2, 2007.
(60) Provisional application No. 60/985,140, filed on Nov. 2, 2007.

(51) Int. Cl. G06F 3/045

(52) U.S. Cl. 345/174

(57) ABSTRACT

A touchpad, wherein proximity sensing is increased by modifying existing touch-sensitive capacitance touchpad technology, wherein the first method is to increase the gain of a SENSE P electrode of the touchpad, wherein a new balancing circuit is created on the SENSE N electrode to prevent circuit saturation, and wherein the touchpad can also be operated as a typical touch-sensitive device by opening a switch on the new SENSE N circuit, and wherein a second method is to increase a distance between the sense electrode and the touchpad sensor electrodes, and to increase the thickness of the sensor and sense electrodes.

### CROSS REFERENCE TO RELATED APPLICATIONS

This document claims priority to and incorporates by reference all of the subject matter included in the provisional patent application docket numbers 4127.CIRQ.PR, having Ser. No. 60/985,133 and filed on Nov. 2, 2007, and 4128.CIRQ.PR, having Ser. No. 60/985,140 and filed on Nov. 2, 2007.

### BACKGROUND OF THE INVENTION

1. Field of the Invention

This invention relates generally to touchpads. More specifically, the present invention is a system for performing proximity or far field sensing using a device that also includes the capability of operating as a touch sensitive device.

2. Description of Related Art

There are several designs for capacitance sensitive touchpads. One of the existing touchpad designs that can be modified to work with the present invention is a touchpad made by CIRQUE® Corporation. Accordingly, it is useful to examine the underlying technology to better understand how any capacitance sensitive touchpad can be modified to work with the present invention.

The CIRQUE™ Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Pointing object position determination is then performed by using an equation that compares the magnitude of the two signals measured.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention.

The process above is repeated for the Y or column electrodes 14 using a P, N generator 24

Although the CIRQUE® touchpad described above uses a grid of X and Y electrodes 12, 14 and a separate and single sense electrode 16, the sense electrode can actually be the X or Y electrodes 12, 14 by using multiplexing. Either design will enable the present invention to function.

### BRIEF SUMMARY OF THE INVENTION

In a preferred embodiment, the present invention is a touchpad, wherein proximity sensing is increased by modifying existing touch-sensitive capacitance touchpad technology, wherein the first method is to increase the gain of a SENSE P electrode of the touchpad, wherein a new balancing circuit is created on the SENSE N electrode to prevent circuit saturation, and wherein the touchpad can also be operated as a typical touch-sensitive device by opening a switch on the new SENSE N circuit, and wherein a second method is to increase a distance between the sense electrode and the touchpad sensor electrodes, and to increase the thickness of the sensor and sense electrodes.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of operation of a first embodiment of a touchpad that is found in the prior art, and which is adaptable for use in the present invention.

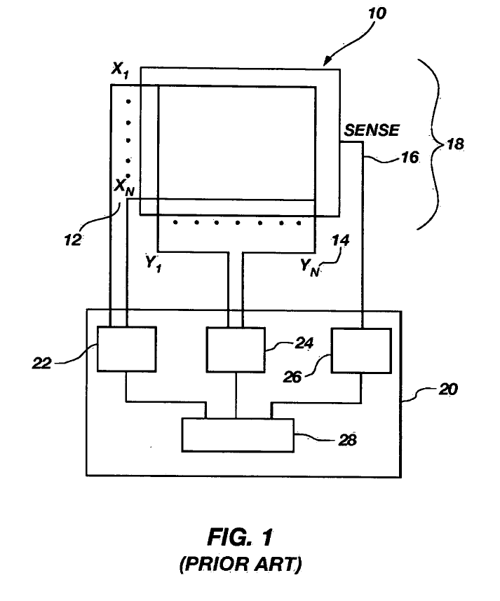

FIG. 2 is a schematic diagram showing modifications to circuitry between the touchpad and the sensor circuitry that enable the touchpad to perform proximity sensing.

FIG. 3 is a block diagram that illustrates the distance that separates the sense line from the X and Y drive electrodes of the touchpad, to thereby increase a detection distance of the touchpad.

### DETAILED DESCRIPTION OF THE INVENTION

Reference will now be made to the details of the invention in which the various elements of the present invention will be described and discussed so as to enable one skilled in the art to make and use the invention. It is to be understood that the following description is only exemplary of the principles of the present invention, and should not be viewed as narrowing the claims which follow.

The first embodiment of the invention is a circuit that is added to a touchpad in order to increase sensitivity of the touchpad for proximity sensing.

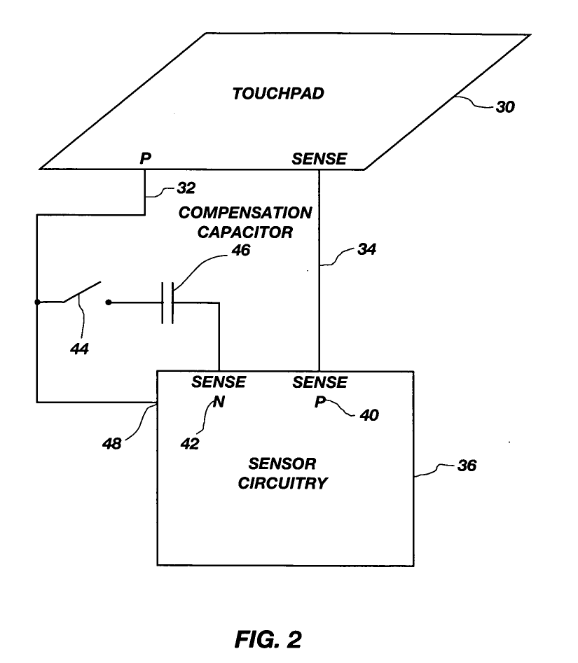

FIG. 2 is a block diagram of a touchpad 30 showing sensor P (positive) electrodes 32 and a sense line 34 that are coupled to sensor circuit 36. The sense line 34 is typically coupled to the SENSE P (positive) input 40, so this is not a modification to an existing touchpad design. However, the sensor P electrodes 32 is not typically coupled to the SENSE N (negative) input 42.

It is noted that the sensor P electrodes 32 may be either an X or Y electrode in a multi-layer touchpad or an X electrode in a single-layer touchpad. The sensor P electrodes 32 and the sense line 34 are coupled to touchpad sensor circuitry 36. The touchpad sensor circuitry 36 analyzes the signals received by the sense line 34 to determine if an object is being detected, and where the object is located with respect to the touchpad 30.

To increase the sensitivity of the touchpad 30 to thereby be able to detect objects at a greater distance from the touchpad, the gain is increased on the SENSE P input 40. Those skilled in the art of touchpad circuitry understand the methods that can be used for increasing the gain on the SENSE P input 40, and these methods are not considered an aspect of the invention.

Increased sensitivity of the SENSE P input 40 will typically mean that a signal from the sense line 34 might become saturated because the touchpad sensor circuitry is unable to reestablish balance on the sense line. To compensate for the increased amplitude of the signal on the sense line 34, and thus the increased sensitivity, a new balancing circuit is created between the SENSE N input 42 and the touchpad 30. This new balancing circuit enables the touchpad sensor circuitry 36 to reestablish balance on the sense line 34.

The SENSE N input 42 is typically left disconnected in the touchpad sensor circuitry 36. When the signal at the SENSE P input 40 increases in amplitude to a certain threshold, a switch 44 is closed. Switch 44 couples the sensor P electrodes 32 to the SENSE N input 42 through a compensation capacitor 46. The sensor P electrodes 32 are positive in value. However, because they are coupled to the SENSE N input 42, the value is inverted. The SENSE N input 42 is now countering the effect of the large positive signal on the sense line 34 that is at the SENSE P input 40. The touchpad sensor circuitry 36 is now able to restore balance on the sense line 34.

Eventually the signal on the sense line 34 will decrease in value as a detected object moves away from the touchpad 30. When the signal has decreased sufficiently, the touchpad sensor circuitry 36 will open switch 44, thereby removing any input to SENSE N input 42. The touchpad sensor circuitry 36 should now be capable of restoring balance on the sense line 34 without the added assistance of the SENSE N input 42.

It is noted that the sensor P electrodes 32 continue to always be coupled to the touchpad sensor circuitry 36 at input 48. This input is not disturbed by the connection to SENSE N input 42 when switch 44 is closed.

Accordingly, the invention is not only a method of adapting a touch-sensitive touchpad to operate in a proximity sensing mode, but is also the fact that the touchpad can be modified on the fly to again operate in a standard touch-sensitive mode of operation.

The method described above is a first method of increasing sensitivity or the detection range of a proximity sensitive touchpad. A second method is now described herein. The second method involves changing the physical configuration of electrodes in the touchpad itself.

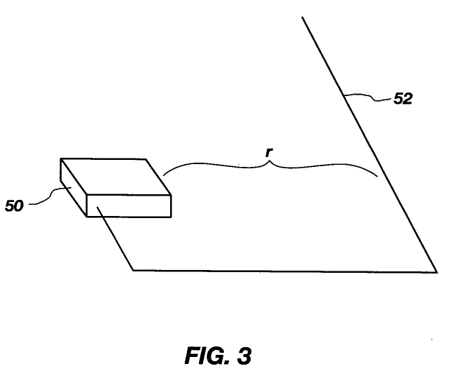

In FIG. 3, the second embodiment of the invention is a touchpad wherein the SENSE line is physically separated from the drive electrodes X and Y of the touchpad. The CIRQUE® Corporation touchpad operates by being able to detect objects that are a function of the distance between the SENSE line and the X and Y drive electrodes of the touchpad. Increasing the distance between the SENSE line and the drive electrodes correspondingly increases the distance to objects that are detectable by the touchpad. Thus, the touchpad can also operate as a proximity sensitive device by simply creating a gap between the drive electrodes and the SENSE line.

FIG. 3 shows a touchpad 50 and a SENSE line 52. The SENSE line 52 is separated from the touchpad 50 by a distance r. The touchpad 50 is now able to detect objects that are also this distance r away from the touchpad. As a practical matter, the distance r that a touchpad 50 can accurately work may vary greatly depending upon the characteristics of the touchpad. Nevertheless, a touchpad 50 should be able to detect objects at a distance of several meters. Accordingly, it should not be surprising that the distance can be increased substantially.

Another factor that affects the ability to detect objects at a distance is the thickness of the electrodes. Surface area of the electrodes will also affect the ability to detect objects at a distance. Typical touchpad 50 electrodes are only as thick as typical traces on a printed circuit board. However, by intentionally creating thicker electrodes, the area of the electrodes is increased, thereby resulting in a longer detection distance.

It is believed that the effective detection distance drops off at a rate of 1/r².

The invention is not only a method of adapting a touch-sensitive touchpad to operate in a proximity sensing mode, but is also the fact that the touchpad can still operate in a standard touch-sensitive mode of operation.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for increasing gain of a proximity sensitive device, said method comprising the steps of:
1) providing a touchpad having a plurality of sensor electrodes and a sense line that indicates the presence of a detectable object, wherein the plurality of sensor electrodes and the sense line are coupled to a touchpad sensor circuit;
2) increasing gain of a signal on the sense line to thereby increase a distance of proximity sensing; and
3) adding a new balancing circuit between the touchpad and the touchpad sensor circuit, wherein the balancing circuit enables the touchpad sensor circuit to compensate for an increased signal on the sense line and reestablish balance on the sense line.

2. The method as defined in claim 1 wherein the method further comprises the step of providing a plurality of sensor P electrodes, and a SENSE N input and a SENSE P input on the touchpad sensor circuit, wherein the SENSE N input receives input from the plurality of sensor P electrodes through a compensation capacitor to thereby enable the touchpad sensor circuit to balance the signal on the sense line when the signal is growing large enough to saturate the SENSE P input.

3. The method as defined in claim 2 wherein the method further comprises the step of closing a switch to couple the plurality of sensor P electrodes to the SENSE N input when the signal on the SENSE P input passes a threshold amplitude.

4. The method as defined in claim 3 wherein the method further comprises the step of setting the threshold amplitude below a saturation level of the SENSE P input.

5. The method as defined in claim 4 wherein the method further comprises the step of opening the switch between the sensor P electrodes and the SENSE N input when the signal on the sense line descends below the threshold amplitude.

6. A method for increasing gain of a proximity sensitive device, said method comprising the steps of:
1) providing a touchpad having a plurality of sensor electrodes and a sense line that indicates the presence of a detectable object, wherein the plurality of sensor electrodes and the sense line are coupled to a touchpad sensor circuit; and
2) physically increasing a distance between the sense line and the sensor electrodes, wherein the distance of a detectable object is a function of the distance between the sense line and the sensor electrodes.

7. The method as defined in claim 6 wherein the method further comprises the step of increasing a thickness of the sensor electrodes and the sense line to thereby increase a distance that the object can be detected.
